(19) United States
(12) Patent Application Publication
(10) Pub. No.: US 2019/0017319 A1
(43) Pub. Date: Jan. 17, 2019

(54) AUTOMATIC OPERATION OF BUILDING WINDOW USING MAGNETIC FIELDS

(71) Applicant: John Duffy, Green Bay, WI (US)

(72) Inventor: John Duffy, Green Bay, WI (US)

(21) Appl. No.: 15/648,973

(22) Filed: Jul. 13, 2017

(51) Int. Cl. E06B 9/52; E05F 15/60; E05B 47/00

(52) U.S. Cl. CPC E06B 9/52; E05F 15/60; E05B 47/0004; E05Y 2900/148; E06B 2009/524; E06B 2009/528; E05B 2047/0068

(57) ABSTRACT

An apparatus and method for moving a window sash relative to a window frame. A window comprises a frame and a sash pivotally connected to the frame. A plurality of members are positioned between the sash and the frame, and the plurality of members are arranged in a series. A plurality of magnet sets comprise at least a first magnet operably connected to one member in the series of members and at least a second magnet operably connected to another member in the series of members. The first magnet is adjacent the second magnet, and at least one of the first or second magnets is an electromagnet. Energizing the electromagnets causes the members in the series of members to move relative to each other and causes the sash to move relative to the frame.

### TECHNICAL FIELD

This patent document relates to windows and more particularly to automatic operation of a building window using magnetic fields.

### BACKGROUND

A common type of window installed in building are windows that have a pivoting sash. These windows are sometimes used as a primary window and place within reach of people who might open or closes them. Other times, they are place high on a wall above a non-opening window or toward the floor below such a window. In these arrangements, the windows are commonly used to ventilation, but may be inconvenient or even difficult for a person to reach. Whether it is a convenience or a necessary function, it is desirable to automate operation of such windows.

### SUMMARY

One aspect of this patent document is an apparatus for moving a window sash relative to a window frame. The apparatus comprises a window, which in turn comprises comprising a frame and a sash pivotally connected to the frame. A plurality of members are positioned between the sash and the frame, and the plurality of members are arranged in a series. The apparatus further comprises a plurality of magnet sets. Each magnet set comprises at least a first magnet operably connected to one member in the series of members and at least a second magnet operably connected to another member in the series of members. The first magnet is adjacent to the second magnet, and at least one of the first or second magnets is an electromagnet. Energizing the electromagnets causes the members in the series of members to move relative to each other and causes the sash to move relative to the frame.

Another aspect of this patent document is a method for moving a window sash pivotally connected to a window frame, wherein a plurality of magnet sets are positioned between the sash and the frame in an accordion arrangement, and each magnet set has at least a first and at least a second magnet. The method comprises conducting an electrical current though the first magnet, the electrical current generating a magnetic field; moving at the second magnet relative to the first magnet; and pivoting the sash relative to the frame in response to moving the second magnet in response to the magnetic field generated by the first magnet.

### BRIEF DESCRIPTION OF THE DRAWINGS

FIG. 1 is an isometric view of a window that can be operated with magnetic fields while the window is closed.

FIG. 2 is an isometric view of the window illustrated in FIG. 1 while the window is open.

FIG. 3 is a partial, isometric view of the window illustrated in FIGS. 1 and 2 while the window is opening.

FIG. 4 is a partial, isometric view of the window illustrated in FIGS. 1 and 2 while the window is closing.

FIG. 5 is a partial top plan view of the window illustrated in FIG. 1 with cross sectional breakouts showing a solenoid and sensor

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Whenever appropriate, terms used in the singular also will include the plural and vice versa. The use of “a” herein means “one or more” unless stated otherwise or where the use of “one or more” is clearly inappropriate. Use of the terms “or” and “and” means “and/or” unless stated otherwise or otherwise clear from the context of the related language. The use of “comprise,” “comprises,” “comprising,” “include,” “includes,” “including,” “has,” and “having” are interchangeable and not intended to be limiting. The term “such as” also is not intended to be limiting. For example, the term “including” shall mean “including, but not limited to.”

In general terms, this patent document related to a mechanism and method of automatically opening windows that have a pivoting sash. The windows are operated using electromagnets to generate electrical fields and controlling the polarity of those fields to open or close the sash. This document may interchangeable discuss opening and closing the window or opening and closing the sash. Both mean the same thing.

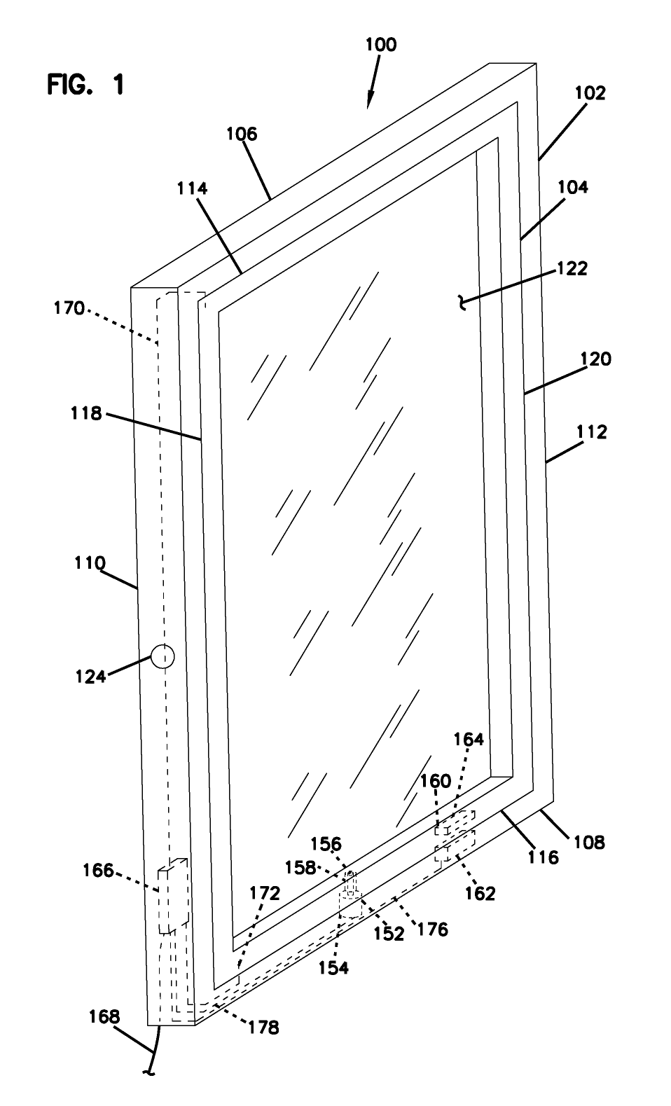

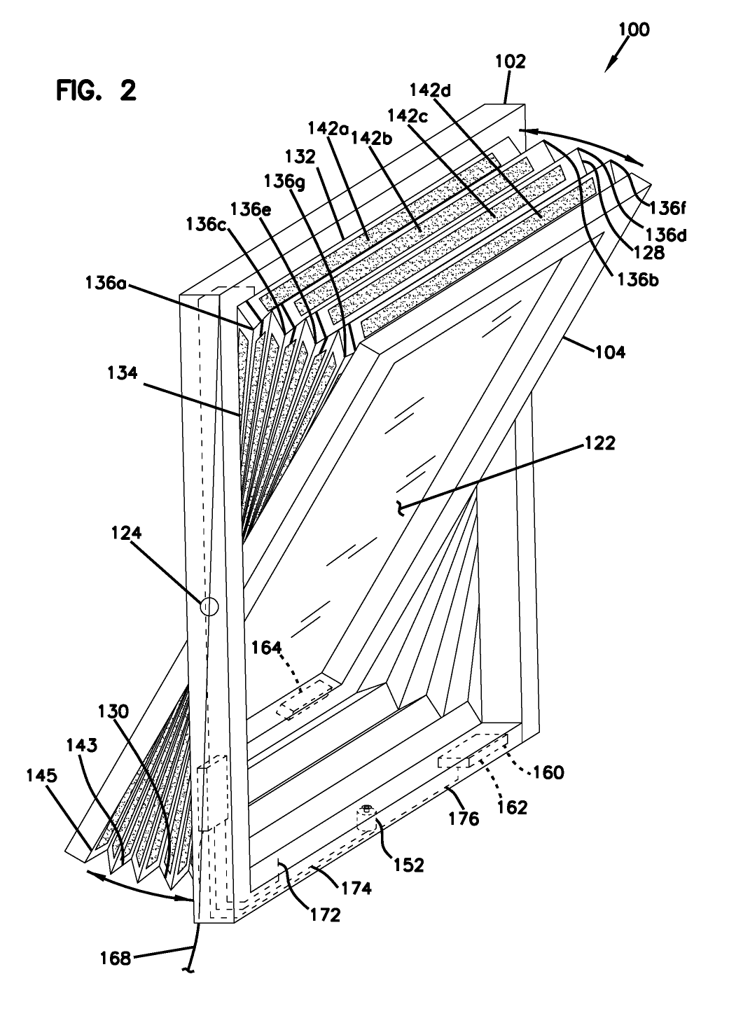

Referring now to FIGS. 1-4, a window 100 has a frame 102 and a sash 104 that pivots relative to the frame 102. In the illustrated embodiment, the sash 104 pivots on the side to form a horizontal pivoting window. The window 100 can have a closed position as illustrated in FIG. 1 and an open position illustrated in FIG. 2. The frame 102 has a head 106 extending along the top, a sill 108 extending along the bottom. First and second jams 110 and 112 are positioned on opposite sides of the frame 102 and extend between the head 106 and the sill 108. In various embodiments, the frame 102 can include additional components such as seals, casings, stools, cladding, and other components.

The sash 104 has upper and lower rails 114 and 116. First and second stiles 118 and 120 are positioned on opposite sides of the sash 104 and extend between the upper and lower rails 114 and 116. One or more panes of glass 122 are mounted in the sash 104. In various embodiments, the sash 104 can include sash bars or muttons, cladding, and other components. The frame 102 and the sash 104 can be made with any suitable material such as wood, aluminum and other metals, composites, and fiberglass.

First and second pivot hinges 124 and (not shown) are connected between the frame 102 and the sash 104 such that the first pivot hinge 124 is connected between the first jam 110 and the first stile 118, and the second pivot hinge (not shown) is connected between the second jam 112 and the second stile 120. In the illustrated embodiment, the first and second hinges 124 and (not shown) are mounted half way between the upper and lower rails 114 and 116 of the sash 104 so that the top and bottom portions of the sash 104 are equally weighted. Alternative embodiments of the window 100 also can include other components such as locks and keepers.

In alternative embodiments, however, the pivots hinges 124 and (not shown) can be mounted anywhere along the length of the stiles 118 and 120. For example, the pivot hinges 124 and (not shown) can be mounted toward the upper rail 114 to provide an awning window. In another example, the pivot hinges 124 and (not shown) can be mounted toward the bottom of the stiles 118 and 120 to provide a hopper window. In yet other alternative embodiments, the first and second pivot hinges 124 and (not shown) can be mounted between the head 106 and the upper rail 114 and between the sill 108 and the lower rail 116, respectively. In this alternative embodiment, the sash 104 pivots vertically and the window is a vertically pivoting casement window.

An upper screen 128 is connected between the frame 102 and the sash 104 above the first and second pivot hinges 124 and (not shown). The upper screen 128 has an upper portion 132 that extends between head 106 and upper rail 114, a first side portion 134 that extends between the first jam 110 and the first stile 118, and a second side portion (not shown) that extends between the second jam 112 and the second stile 120. The upper screen 128 is formed with strands of material that are woven into a fabric. Examples of materials that can be used include metal wire, fiberglass, and other composites. In at least some embodiments, described in more detail herein, the upper screen 128 can be woven with two or more materials in which at least one of the materials is an electrically conductive material, such as a metal wire, that can be used to form an electrical coil. The lower screen 130 is substantially similar to the upper screen 128 and has a lower portion 143, a first side portion 145, and a second side portion (not shown).

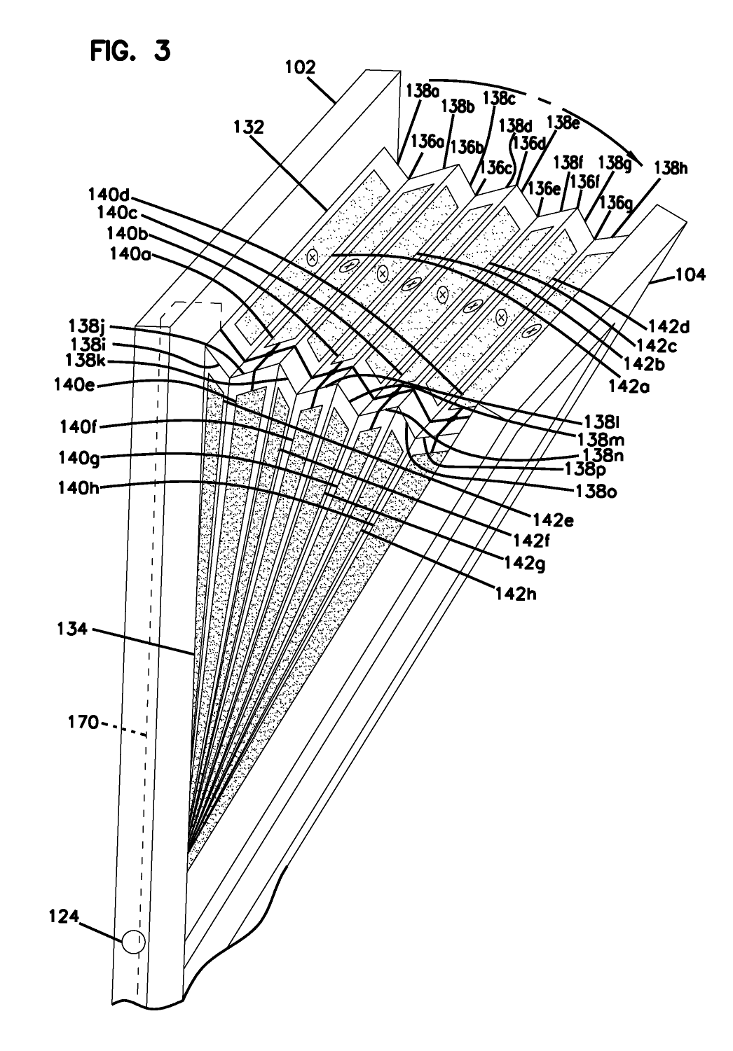

Referring now to FIGS. 2 and 3, the upper screen 128 has a plurality of accordion folds 136a-136g or pleats between the frame 102 and the sash 104. The accordion folds 136a-136g form a series of panels 138a-138p extending between the frame 102 and the sash 104. The members or panels 138a-138p alternate between facing the frame 102 (e.g., panels 138b, 138d . . . 138p) and facing the sash 104 (e.g., panels 138a, 138c . . . 138o) so that adjacent panels (e.g., panels 138c and 138d, and 138d and 138e) directly oppose or face each other. The number of panels and the depth of the panels can vary in alternative embodiments of the upper screen 128. When the sash 104 is in a closed position, the accordion folds 136a-136g are folded substantially flat so that adjacent panels (e.g., 138d and 138e) are substantially parallel and are positioned against each other or at least substantially close to each other. As the window 100 or sash 104 is moved to the open position, the angle between adjacent panels increases. The farther the sash 104 is open, the greater the angle between the panels 138a-138p.

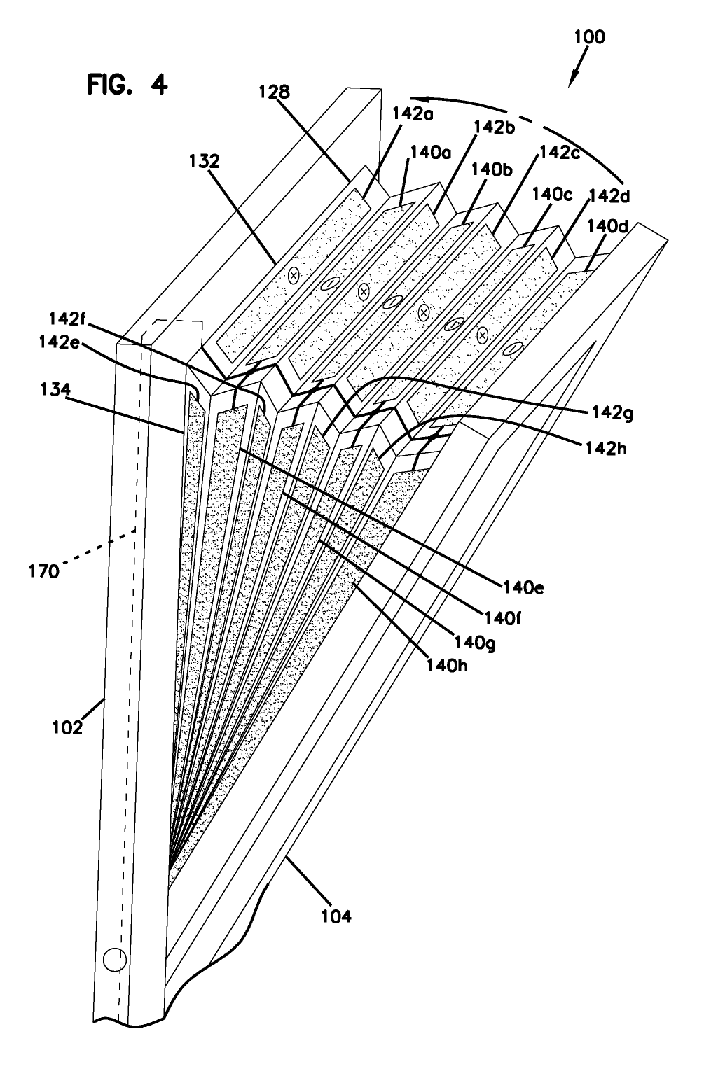

A plurality of electromagnets 140a-140h and permanent magnets 142a-142h are mounted on the upper screen 128. At least one electromagnet (e.g., 142b) is mounted on a panel (e.g., 138d), and at least one permanent magnet (e.g., 142a and 142b) is mounted on at least one adjacent panel (e.g., 138c and 138e) and directly opposes the at least one electromagnet (e.g., 142b). In this configuration, when the electromagnets 140a-140h are energized and have the same polarity as the permanent magnets 142a-142h as illustrated in FIG. 3 they will repel the permanent magnet 142a-142h thereby moving adjacent panels 138a-138p apart and pivoting the sash 104 away from the frame 102 to open the window 100. When the electromagnets 140a-140h are energized with a polarity opposite to the polarity of the permanent magnets 142a-142h as illustrated in FIG. 4 the opposite polarity they will attract the permanent magnets 142a-142h moving the adjacent panels 138a-138p closer together thereby pivoting the sash 104 toward the frame 102 and closing the window 100. Alternative embodiments can include members other than panels to support the magnets.

A set of magnets can include one or more electromagnets (e.g., 140b) on one panel (e.g., 138d) and one or more magnets, either permanent or electromagnets (e.g., 142b), on an adjacent panel (e.g., 138c). Alternatively, a set of magnets can include one or more electromagnets (e.g., 140b) on one panel (e.g., 138d) and one or more magnets, either permanent or electromagnet (142b or 142c), on panels (e.g., 138c or 138e) adjacent to either side of the one panel (e.g., 138d).

In alternative embodiments, the screen 128 can include a frame (not shown) to support the panels 138a-138p when the magnetic forces are moving the panels 138a-138p to either open or close the sash 104. An advantage of such a frame is that it will help hold the screen 128 taut as the magnetic forces are pushing or pulling the panels 138a-138p so that movement of the panels 138a-138p and movement of the sash 104 is more responsive to the magnetic fields. Having too much give in the screen 128 when a force is exerted against it will make movement of the sash 104 less responsive to the magnetic forces. An example of such a frame has elongated members along each of the accordion folds 136a-136g and cross members pivotally connected between adjacent elongated members. In these embodiments, the frame outlines each of the panels 138a-138p. Other embodiments that provide for a taut screen 128 are possible. For example, the screen 128 can be made with very stiff wire or fiber strands.

The electromagnets 140a-140h can be formed by relatively flat coils wrapped around an axis. In alternative embodiments, the coil can be wrapped around a core (not shown) formed with a ferromagnetic material. The core can be configured and positioned to help control and direct the magnetic field generated by the coils. The electromagnets 140a-140h can be attached directly to the screen 128 or mounted on a substrate that is in turn attached to the screen 128. In alternative embodiments, the electrically conductive wire forming the electromagnets 140a-140h can be used as the strands to form the screen 128 or to form at least a part of the screen 128 along the panels 138a-138p. In this embodiment, the wires of the coil are woven directly into the fabric of screen 128.

The permanent magnets 142a-142h can be substantially flat and mounted directly to the screen 128 or can be mounted to a substrate, which is in turn mounted directly to the screen 128. In an example embodiment, the electromagnets 140a-140h and permanent magnets 142a-142h are as flat as possible so that the accordion folds 136a-136g can be folded substantially flat when the window 100 is closed.

Additionally, each panel 138a-138p can have a single electromagnet or permanent magnet mounted on it as illustrated in the figures. In alternative embodiments, a plurality of electromagnets or permanent magnets can be mounted on the panels 138a-138p. In these embodiments, the magnets on a single panel 138a-138p can be spaced from each other to allow airflow through the screen 128. The panels 138a-138p are substantially flat. In alternative embodiments some or all of the panels 138a-138p can be curved or have a curved surface.

In yet other alternative embodiments, a second plurality of electromagnets can be used in place of the permanent magnets 142a-142h. When closing the sash 104 in these alternative embodiments, adjacent electromagnets are energized with electrical current flowing in opposite directions to provide electromagnets on adjacent panels with opposite polarities so the adjacent panels are attracted to each other. When opening the sash 104, adjacent electromagnets are energized with electrical current flowing in the same direction to provide electromagnets on adjacent panels with the same polarity so the adjacent panels are repelled from each other.

In an exemplary embodiment, the number and size of the panels are such that adjacent panels are at an angle to each other even when the sash 104 is pivoted as far as it can go and the window 100 is fully open. Having the adjacent panels at angles to each other when the sash 104 is fully open enables the electromagnets 140a-140h and permanent magnets 142a-142h to exert enough attractive force toward each other (when they have opposite polarities) to pull the panels together and pivot the sash 104 toward the closed position.

In an example embodiment as illustrated, sets of opposing magnets are mounted on panels that run along the upper portion 132 of the screen 128, along the first side 134 of the screen 128, and along the second side of the screen 128. Having magnets on all three sides of the screen 128 maximizes the total attractive and repulsive forces provided by the magnetic fields. Alternative embodiments can have opposing magnet sets along less than all three sides of the screen 128 so long as the magnetic forces between the sets of magnets 140a-140h and 142a-142h is strong enough to move the sash 104 along its entire range of motion—between a fully closed position and a fully open position. In other alternative embodiments, the magnets 140a-140h and 142a-142h are mounted on a structure other than a screen that holds the magnets 140a-140h and 142a-142h in a position that allows them to exert forces against each other through the sash's 104 entire range of motion.

Although the screen is illustrated as supporting the magnets 140a-140h and 142a-142h, alternative embodiments can include a structure other than a screen to support the magnets. For example, a series of members or panels can be used in place of the screen panels 138a-138p to support the magnets. Such members can be formed with fabric other than screening, solid panels, or similar structures that are able to move relative to each other along the path of movement for the sash. Additionally, the panels 138a-138p can be flexibility or rigid. The panels 138a-138p can be formed with either an inelastic or elastic material. Yet other embodiments include a frame structure having members that support the magnets and pivot or otherwise move relative to each other. A possible example is a scissor-type of frame.

The lower screen 130 is substantially similar to the upper screen 128 and includes a lower portion 143, a first side portion 145, and a second side portion (not shown). The lower screen 130 has a series of accordion folds that form panels. A series of electromagnet and permanent magnets are mounted on the panels similar to the electromagnets and permanent magnets mounted on the upper screen.

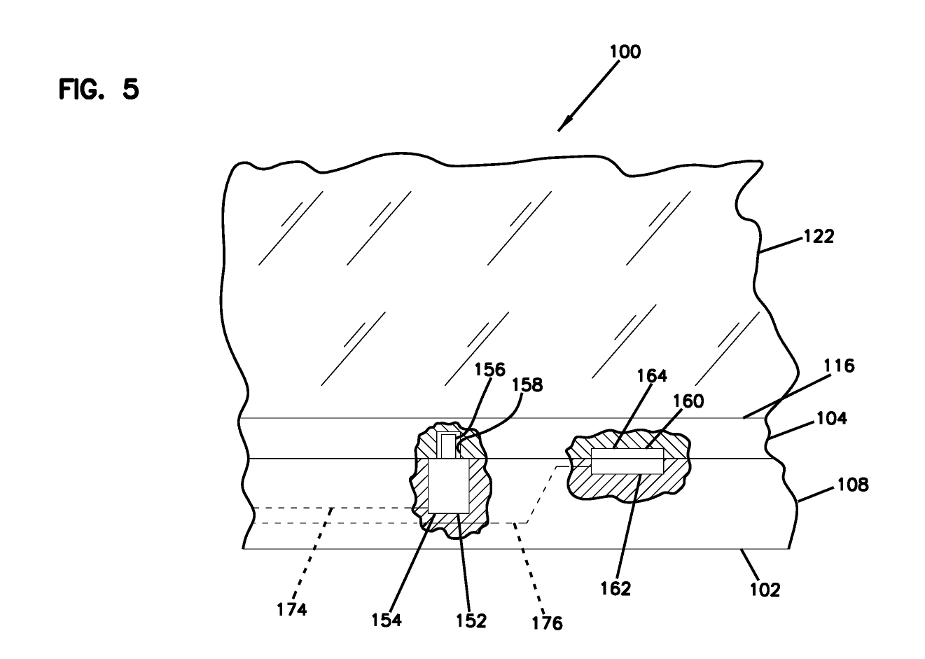

Referring now to FIGS. 1, 2, and 5, a linear electromechanical solenoid 152 has a body 154 with an electromagnetic coil wrapped around an axis and an armature 156 positioned along the axis and at least partially within the electromagnetic coil. The solenoid 152 has an engaged position in which the armature 156 is extended from the body 154 and an unengaged position in which the armature 156 is withdrawn into the body 154. The solenoid 152 is a latching solenoid so that the armature 156 maintains its set position (e.g., in the extended or engaged position, or retracted or unengaged position). An advantage of the latching solenoid is that it does not draw any energy when the armature 156 is in the engaged position or the unengaged position.

In the example embodiment, the solenoid 152 is mounted in the frame 102. The sash 104 defines a locking hole 158 that is sized to receive the armature 156. The locking hole 158 is open to the outer perimeter of the sash 104. When the window 100 is in a closed position, the locking hole 158 directly opposes the solenoid 152 and is aligned with the armature 156. In alternative embodiments, the solenoid 152 can be mounted external to the frame 102 and an external piece of hardware such as an eye or pad eye, can be mounted on the sash 104 and positioned to receive the armature 156 from the solenoid 152.

When in the sash 104 is in the closed position, the solenoid 152 is engaged so that the armature 156 is extended into the locking hole 158 and engaging the sash 104. This arrangement prevents the permanent magnets 142a-142h from repelling each other and opening the sash 104. When the window 100 is to be opened, the armature 156 of the solenoid 152 is actuated and the armature 156 is withdrawn from the locking hole 158 and into the solenoid body 154. The sash 104 is then free to pivot provided there is no other locking mechanism securing the sash 104 to the frame 102 and preventing it from pivoting.

Alternative embodiments can use a solenoid other than a linear electromechanical solenoid. Examples of other solenoids include a rotational solenoid, a pneumatic solenoid, or a hydraulic solenoid. Other embodiments can use manual or automated mechanisms other than a solenoid to hold the sash 104 in the closed position. Yet other embodiments do not use any mechanism other than the weight of the sash 104 to hold the sash 104 in the closed position.

A sensor 160 is mounted on the frame 102 and/or sash 104 to detect when the sash 104 is open or fully closed. The sensor 160 enables the controller 166, discussed herein, to determine when the sash 104 is closed and when to actuate the solenoid 152 to move the armature 156 into the engaged position. An example of such a sensor 160, as illustrated in the figures, is a reed switch 162 mounted in the frame 102 and a sensor magnet 164 mounted in the sash 104. In this embodiment, the sensor magnet 164 is positioned directly opposing the reed switch 162 when the sash 104 is in the closed position. In this embodiment, the sensor magnet 164 throws the reed switch 162 into one state when the sash 104 is moved into the closed position. The reed switch 162 is then moved into the opposite state when the sash 104 is opened and the sensor magnet 164 is moved away from the reed switch 162. Depending on how the controller 166 is configured, the reed switch 162 can be a normally open or normally closed switch. Alternative embodiments can use sensors other than a reed switch such as capacitive sensors, photoelectric sensors, inductive sensors, and ultrasonic sensors. Angular positon sensors such as optical or magnetic encoders also can be used. Such angular position sensors would be axially aligned with the pivot hinges 124 and (not shown). Yet, other embodiments do not use any sensor and rely on the user to determine when the solenoid 152 should be actuated.

A controller 166 is also embedded in the frame 102 and is electrically connected to the electromagnets 140a-140h on the upper screen 128 and lower screen 130 with electrical conductors 170 and 172, respectively. The controller 166 has a switching mechanism that controls the flow of electrical current through the electromagnets 140a-140h. In an example embodiment, the controller 166 is switchable between an on/opening state, an on/closing state, and an off state. When in the on/opening state, the controller 166 delivers an electrical current through the electromagnets 140a-140h in one direction to generate a magnetic field having the same polarity as the permanent magnets 142a-142h. When in the on/closing state, the controller 166 delivers an electrical current through the electromagnets 140a-140h in an opposite direction so that the electromagnets 140a-140h have a polarity opposite to the polarity of the permanent magnets 142a-142h. In the off state, the controller 166 is electrically disconnected from the electromagnets 140a-140h so that the electromagnets 140a-140h do not generate any magnetic fields and do not attract or repel the sash 104 to open or close it. The controller 166 can be switched to the off state when the window 100 is closed or when the sash 104 is open and in a desired rotational position. In alternative embodiments, the controller 166 is programmed or otherwise wired to automatically transition from the on/closing state to the off state after the solenoid 152 is actuated and the armature 156 enters the locking hole 158.

The controller 166 also is electrically connected to the solenoid 152 and sensor 160 by conductors 174 and 176, respectively, and controls operation of the solenoid 152 to move the armature 156 between the engaged and unengaged positions. In operation, when the sash 104 is moved into the closed position, the solenoid 152 would be actuated and the armature 156 moved from the unengaged position to the engaged position so that the solenoid armature 156 would move into the locking hole 158 and secure the sash 104 in the closed position. When the controller 166 is changed to the on/opening state, the controller 166 actuates the solenoid 152 to withdraw the solenoid armature 156 from the locking hole 158 and entirely within the frame 102. The sash 104 can then pivot past the solenoid 152 and open. When the controller 166 is in the off state, the controller 166 does not deliver any electrical current to the solenoid 152.

In an example embodiment, the controller 166 is wired to a 120/220 Volt alternating current power source 168 such as the building electrical wiring. The controller 166 can then include a transformer to step down the voltage; a rectifier to convert the alternating current to a direct current; discrete electrical components to filter and condition the electrical signals and current delivered to the electromagnets 140a-140h, solenoid 152, sensor 160, and other components of the controller 166; a first set of switches arranged to switch the direction of the electrical current delivered to the electromagnets 140a-140h or to electrically disconnect the electromagnets 140a-140h from the controller 166; a second set of switches arranged to switch the direction of the electrical current delivered to the solenoid 152 or to electrically disconnect the solenoid 152 from the controller 166; and a programmable circuit programmed and arranged to receive input from the sensor 160, switches, or other control elements. Additionally, the controller 166 can include a wireless interface to control the window 100 through a wireless interface. The wireless interface can use any type of suitable wireless standard such as Bluetooth™ or any of the IEEE 802.11 wireless standards. A wireless interface can enable control of the window through remote devices such as home automation systems; applications on smart phones, tablet computers, and other computers; and dedicated remote control units.

In alternative embodiments, the controller 166 can include manual actuators that a user can throw to control the flow of electrical current to the electromagnets 140a-140h and solenoid 152. In yet other alternative embodiments, the controller 166 can include adjustable electrical components such a potentiometers or other adjustable electrical components to control the amplitude of the electrical current delivered to the electromagnets 140a-140h. An advantage of these embodiments is the rate at which the sash 104 pivots can be adjusted. These embodiments also enable the controller 166 to be calibrated to provide enough force to pivot the sash 104 into the fully closed position. Alternative embodiments also might include batteries, either rechargeable or disposable, as the main power source in place of the 120/220 Volt alternating current power supply 168. In these battery-operated embodiments, the controller 166 may not require a transformer or rectifier.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. An apparatus for moving a window sash relative to a window frame, the apparatus comprising:
a window comprising a frame and a sash pivotally connected to the frame;
a plurality of members positioned between the sash and the frame, the plurality of members arranged in a series;
a plurality of magnet sets, each magnet set comprising at least a first magnet operably connected to one member in the series of members and at least a second magnet operably connected to another member in the series of members, the first magnet being adjacent the second magnet, at least one of the first or second magnets being an electromagnet; and
wherein energizing the electromagnets causes the members in the series of members to move relative to each other and causes the sash to move relative to the frame.

2. The apparatus of claim 1 wherein the sash is pivotally connected to the frame.

3. The apparatus of claim 2 wherein the window is selected from the group comprising: awning window, hopper window, casement window, horizontal-pivot window, vertical pivot window, and combinations thereof.

4. The apparatus of claim 2 wherein:
the sash has two oppositely disposed end portions and a middle portion between the two oppositely disposed end portions;
and the sash is pivotally connected to the frame at the middle portion.

5. The apparatus of claim 2 wherein:
the sash has two oppositely disposed end portions and a middle portion between the two oppositely disposed end portions;
and the sash is pivotally connected to the frame at one of the end portions.

6. The apparatus of clam 1 wherein the one member and the another member pivot relative to each other.

7. The apparatus of claim 6 wherein the one member and the another member comprise screening.

8. The apparatus of claim 7 further comprising screen operably connected between the frame and the sash, the screen comprising:
a plurality of accordion folds between the frame and the sash, each accordion fold comprising alternating raised and recessed folds, each fold separating portions of the screen into the member, each member being a panel; and
the first magnet in each magnet set operably connected to a panel on one side of an accordion fold and the second magnet in each magnet set operably connected to a panel on the opposite side of the accordion fold.

9. The apparatus of claim 2 wherein each of the first and second magnets is an electromagnet.

10. The apparatus of claim 2 wherein the first magnet is an electromagnet and the second magnet is a permanent magnet.

11. The apparatus of claim 1 further comprising:
a sensor arranged to detect when the sash is in a fully closed position;
a solenoid, the solenoid comprising an armature, the solenoid arranged so the armature selectively extends between the frame and the sash; and
a controller electrically connected to the senor and the solenoid, the controller configured to determine when the sash is fully closed and to actuate the solenoid and move the armature to a position engaging both the frame and the sash upon detecting the sash is fully closed.

12. A method for moving a window sash pivotally connected to a window frame, wherein a plurality of magnet sets are positioned between the sash and the frame in an accordion arrangement, and each magnet set has at least a first and at least a second magnet, the method comprising:
conducting an electrical current though the first magnet, the electrical current generating a magnetic field;
moving at the second magnet relative to the first magnet; and
pivoting the sash relative to the frame in response to moving the second magnet in response to the magnetic field generated by the first magnet.

13. The method of claim 12 further comprising conducting an electrical current through the second magnet concurrently with conducting an electrical current though the first magnet.

14. The method of claim 12 wherein conducting an electrical current though the first magnet generates a magnetic field having the same polarity as the magnetic field of the second magnet, the method further comprising:
moving the second magnet away from the first magnet in response to generating the magnetic field; and
pivoting the sash to increase the opening of the window in response to moving the second magnet away from the first magnet.

15. The method of claim 14 wherein the second magnet is an electromagnet, the method further comprising:
conducting an electrical current through the second magnet to generate a polarity in the second magnet opposite to the polarity of the first magnet.

16. The method of claim 14 wherein a screen is operably connected between the window sash and the window frame, the screen comprises a plurality of accordion folds forming at least first and second panels, and each magnet set comprises at least the first magnet operably connected to the first panel and at least the second magnet operably connected to the second panel, the method further comprising:
increasing the angle of the accordion fold between the first and second panels in response to moving the second magnet away from the first magnet and pivoting the sash to increase the opening of the window.

17. The method of claim 12 wherein conducting an electrical current though the first magnet generates a magnetic field having the opposite polarity of the magnetic field of the second magnet, the method further comprising:
moving the second magnet toward the first magnet in response to generating the magnetic field; and
pivoting the sash to decrease the opening of the window in response to moving the second magnet toward the first magnet.

18. The method of claim 17 wherein the second magnet is an electromagnet, the method further comprising:
conducting an electrical current through the second magnet to generate a polarity in the second magnet the same as the polarity of the first magnet.

19. The method of claim 17 wherein a screen is operably connected between the window sash and the window frame, the screen comprises a plurality of accordion folds forming at least first and second panels, and each magnet set comprises at least the first magnet operably connected to the first panel and at least the second magnet operably connected to the second panel, the method further comprising:
decreasing the angle of the accordion fold between the first and second panels in response to moving the second magnet toward the first magnet and pivoting the sash to decrease the opening of the window.

20. The method of claim 17 wherein locking the sash to the frame comprises:
actuating a solenoid having an armature upon the window sash being fully closed; and
extending the armature between the frame and the sash upon actuating the solenoid.
